(19) United States
(12) Patent Application Publication
(10) Pub. No.: US 2017/0043624 A1
(43) Pub. Date: Feb. 16, 2017

(54) Tire Including A Casing Layer That Includes Sheathed Casing Reinforcement Elements

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Laurent BUCHER, Clermont-Ferrand Cedex 9 (FR); Philippe LESOEURS, Clermont-Ferrand Cedex 9 (FR); Sébastien RIGO, Clermont-Ferrand Cedex 9 (FR); Aurore LARDJANE, Clermont-Ferrand Cedex 9 (FR); Sébastien NOEL, Clermont-Ferrand Cedex 9 (FR)

(21) Appl. No.: 15/306,314

(22) PCT Filed: Apr. 22, 2015
(86) PCT No.: PCT/EP2015/058718

§ 371 Date: Oct. 24, 2016

(30) Foreign Application Priority Data
Apr. 25, 2014 (FR) 1453721

(51) Int. Cl. B60C 9/00; D07B 1/06; D02G 3/48; B60C 9/06

(52) U.S. Cl. CPC B60C 9/005; B60C 9/0064; B60C 9/06; D07B 1/0633; D02G 3/48; B60C 2009/0269

(57) ABSTRACT

The tire (10) comprises a crown (12) surmounted by a tread (22), two sidewalls (24), two beads (26), each sidewall (24) connecting each bead (26) to the crown (12), a carcass reinforcement (34) anchored in each of the beads (26) and extending in the sidewalls (24) as far as the crown (12). The carcass reinforcement (34) comprises one carcass ply (44) comprising carcass reinforcing elements (46) having a mean laying pitch (P) strictly greater than 1.5 mm. The carcass ply (44) comprises an elastomer matrix (54) in which the carcass reinforcing elements (46) are embedded, each carcass reinforcing element (46) comprising: one filamentary element (56), and one sheath (58) coating the filamentary element (56) and comprising at least one layer (60) of a thermoplastic polymer composition.

The invention applies to industrial vehicles selected from heavy vehicles such as underground trains, buses, road haulage vehicles (lorries, tractors, trailers), off-road vehicles, agricultural vehicles or civil engineering plant, aircraft and handling vehicles.

A tire with a radial carcass (casing) reinforcement for a heavy vehicle is known from the prior art. Such a tire comprises a radial carcass reinforcement anchored in two beads and surmounted radially by a crown reinforcement itself surmounted by a tread which is connected to the beads by two sidewalls.

The carcass reinforcement comprises at least one carcass ply. Each carcass ply comprises reinforcing elements referred to as carcass reinforcing elements arranged side by side parallel to one another and embedded in an elastomer matrix, for example natural rubber. The carcass reinforcing elements make an angle greater than 80° with the circumferential direction of the tire.

In such a tire, the crown reinforcement comprises a working reinforcement, a hoop reinforcement, a protective reinforcement, and, optionally, a triangulation reinforcement. The relative arrangement of these reinforcements relative to one another may vary. In general, the protective reinforcement is the reinforcement that is radially outermost.

The working reinforcement generally comprises two working plies comprising several reinforcing elements referred to as working reinforcing elements. The working reinforcing elements are arranged side by side parallel to one another. The working reinforcing elements make an angle ranging from 10° to 45° with the circumferential direction of the tire. The working reinforcing elements are crossed from one working ply with respect to the other.

The hoop reinforcement generally comprises a single hooping ply. The hooping ply comprises reinforcing elements, referred to as hooping reinforcing elements, arranged side by side parallel to one another. The hoop reinforcing elements make an angle at most equal to 10° with the circumferential direction of the tire.

The protective reinforcement generally comprises a single protective ply. The protective ply comprises reinforcing elements, referred to as protective reinforcing elements, arranged side by side parallel to one another. The protective reinforcing elements make an angle at least equal to 10°, preferably ranging from 10° to 35° and more preferably from 15° to 30° with the circumferential direction of the tire.

The triangulation reinforcement, where present, comprises a single triangulation ply. The triangulation ply comprises reinforcing elements, referred to as triangulation reinforcing elements, arranged side by side parallel to one another. The triangulation reinforcing elements make an angle ranging from 30° to 65° with the circumferential direction of the tire.

The reinforcing elements described hereinabove comprise assemblies comprising several individual metal threads assembled with one another either by cabling or by twisting.

Certain present-day tires are intended to run at high speed over increasingly long journeys. However, certain inevitable incidents lead to a loss of tire pressure leading to prolonged running at low pressure under particularly harsh loading conditions.

During this low-pressure running, the radius of curvature of the tire in the contact patch in which the tire is in contact with the roadway on which it is running is reduced. As a result, the bending and compressive stresses applied to the carcass reinforcing elements are extremely high, particularly at the interface between the carcass reinforcing element and the elastomer matrix in which it is embedded. During prolonged use of the tire under such conditions, the carcass reinforcing element is found to come away through progressive destruction of the interface between the individual metal threads of the assemblies and the elastomer matrix.

In order to improve the endurance of the carcass reinforcement at low pressure, it is notably known practice to increase the density of carcass reinforcing elements in order to distribute the stresses better. The density of carcass reinforcing elements is increased by reducing the pitch between these reinforcing elements, something which does, however, have the disadvantage of making the tire heavier.

It is an object of the invention to allow low-pressure running while at the same time reducing the mass of the tire.

To this end, one subject of the invention is a tire comprising a crown surmounted by a tread, two sidewalls, two beads, each sidewall connecting each bead to the crown, a carcass reinforcement anchored in each of the beads and extending in the sidewalls as far as the crown, the carcass reinforcement comprising at least one carcass ply comprising carcass reinforcing elements arranged side by side parallel to one another in a main direction substantially perpendicular to the overall direction in which the carcass reinforcing elements extend at a mean laying pitch strictly greater than 1.5 mm, the carcass ply comprising an elastomer matrix in which the carcass reinforcing elements are embedded, each carcass reinforcing element comprising:
at least one filamentary element, and
at least one sheath coating the filamentary element and comprising at least one layer of a thermoplastic polymer composition.

By virtue of the sheath, the bending and compressive stresses applied to the interface between the carcass reinforcing element and the elastomer matrix in which it is embedded are reduced. What happens is that, during low-pressure running of the tire according to the invention, the stresses are applied on the one hand to the interface between the elastomer matrix and the sheath and, on the other hand, to the interface between the sheath and the filamentary element. Furthermore, the inventors originating the invention are postulating the hypothesis that the sheath perhaps acts as a cushion, absorbing stresses. This results in better endurance of the carcass ply. Also, for the same tire endurance it is possible, according to the invention, to reduce the density of carcass reinforcing elements and thus make the tire lighter, as demonstrated by the comparative tests described hereinbelow.

Furthermore, the use of the sheath makes it possible to reduce the amount of elastomer matrix needed to protect each filamentary element, the protection being partially afforded by the sheath. Specifically, the sheath constitutes an effective barrier against the corrosive agents liable to penetrate and come into contact with the filamentary elements.

What is meant by a filamentary element is any longilinear element the length of which is great in relation to its cross section, whatever the shape of the latter, for example circular, oblong, rectangular or square, or even flat, it being possible for example for this filamentary element to be twisted or corrugated. When it is of circular shape, its diameter preferably ranges from 1 to 5 mm, more preferably from 1 to 2 mm.

What is meant by a thermoplastic polymer composition is a composition comprising at least one polymer having the properties of a thermoplastic polymer. The composition may contain other polymers, preferably thermoplastic polymers, and possibly elastomers as well as other non-polymer components.

What is meant by an elastomer (or rubber, the two terms being considered to be synonymous), whether when speaking of the matrix or indeed of the thermoplastic polymer composition, is any type of elastomer, whether it be of the diene type or of the non-diene type, for example of the thermoplastic type.

For preference, the elastomer is a diene elastomer and, more preferably, selected from the group consisting of polybutadienes (BR), synthetic polyisoprenes (IR), natural rubber (NR), butadiene copolymers, isoprene copolymers and mixtures of these elastomers. Such copolymers are more preferably selected from the group consisting of stirene-butadiene copolymers (SBR), isoprene-butadiene copolymers (BIR), isoprene-stirene copolymers (SIR), isoprene-butadiene-stirene copolymers (SBIR) and mixtures of such copolymers.

Whatever the form of the carcass reinforcing elements, these extend in an overall direction. The laying pitch is the distance, in the main direction, separating two analogous points of two adjacent reinforcing elements. In other words, the laying pitch is the centre distance between two adjacent reinforcing elements. The main direction is substantially perpendicular to the overall direction in which the carcass reinforcing elements extend.

The mean laying pitch is measured over a total axial width of 10 cm on each side of the median plane of the tire (namely between −5 cm and +5 cm with respect to the median plane of the reinforced product) and averaged over the number of measurements taken (namely, for example, 100 measurements in total if there are 10 reinforcing elements per cm). For each measurement, the laying pitch is measured by measuring the distance, in the main direction, separating two analogous points of two adjacent reinforcing elements.

Advantageously, the mean laying pitch of the carcass reinforcing elements in the main direction is greater than or equal to 1.7 mm, preferably greater than or equal to 1.8 mm and more preferably 1.9 mm. By increasing the laying pitch, the tire is lightened still further. Depending on the low-pressure endurance desired by the person skilled in the art, the latter will determine the maximum conceivable laying pitch for the tire.

Optionally, the mean thickness of the sheath on the back of each filamentary element ranges from 1 μm to 2 mm, preferably from 10 μm and 1 mm and more preferably from 35 μm to 200 μm.

The mean thickness of the sheath is measured over a total axial width of 10 cm on each side of the median plane of the tire (namely between −5 cm and +5 cm with respect to the median plane of the reinforced product) and averaged over the number of measurements taken (namely, for example, 100 measurements in total if there are 10 reinforcing elements per cm). For each measurement, the thickness of the sheath is determined by halving the difference between the size of the reinforcing element and the size of the filamentary element in a direction perpendicular to the main direction, in this instance in the direction substantially parallel to the thickness of the carcass ply.

In one preferred embodiment, each filamentary element comprises an assembly of individual metal threads. This then promotes mechanical anchorage of the sheath around and through the assembly.

By way of example, the assemblies of individual metal threads comprise an internal layer of one or of M>1 individual metal threads and an external layer of P>1 individual metal threads wound in a helix around the internal layer.

In some embodiments using two-layer assemblies, the P>1 individual metal threads of the external layer are wound directly in contact with the M>1 individual metal threads of the internal layer. Examples of such assemblies are those of 1+6 or 3+9 structure.

In other embodiments using three-layer assemblies, the assembly comprises an intermediate layer of N>1 individual metal threads wound in a helix around the internal layer, the P>1 individual threads of the external layer being wound in a helix around the intermediate layer. Examples of such assemblies are those of 1+6+12 or 3+9+15 structure.

For preference, the assembly has no wrapping thread wrapped around the external layer.

What is meant, by definition, by an individual metal thread is a monofilament predominantly (namely over 50% of the mass of which) or wholly (100% of the mass of which) is made of a metallic material. Each monofilament is preferably made of steel, more preferably perlitic (or ferrito-perlitic) carbon steel, denoted hereinafter as “carbon steel”, or even of stainless steel (by definition, steel containing at least 11% of chrome and at least 50% iron).

When a carbon steel is used, its carbon content (% by weight of steel) is preferably comprised between 0.5% and 0.9%. Use is preferably made of a steel of the normal tensile (“NT”) or high tensile (“HT”) steel cord type having a tensile strength (Rm) preferably higher than 2000 MPa, more preferably higher than 2500 MPa (measurement taken under tensile testing in accordance with standard ISO 6892-1 of 2009.

In a preferred embodiment, each individual metal thread has a diameter ranging from 0.10 mm to 0.35 mm, preferably from 0.12 mm to 0.26 mm and more preferably from 0.14 mm to 0.23 mm.

For preference, the thermoplastic polymer composition comprises a thermoplastic polymer, a functionalized diene elastomer, a poly(p-phenylene ether) or a mixture of these materials.

For preference, the functionalized diene elastomer is a thermoplastic stirene elastomer.

In one embodiment, the sheath comprises a single layer of the thermoplastic polymer composition. As an alternative, the sheath comprises several layers, at least one of them comprising a thermoplastic polymer composition.

Use may also be made of the various materials and layers described in applications WO2010/136389, WO2010/105975, WO2011/012521, WO2011/051204, WO2012/016757, WO2012/038340, WO2012/038341, WO2012/069346, WO2012/104279, WO2012/104280 and WO2012/104281.

Advantageously, the sheath is covered with a layer of an adhesive promoting adhesion between the sheath and the elastomer matrix.

The adhesive used is, for example of the RFL (Resorcinol-Formaldehyde-Latex) type or, for example, as described in publications WO2013017421, WO2013017422, WO2013017423.

For preference, the carcass reinforcing elements make an angle ranging from 80° to 90° with the circumferential direction of the tire.

For preference, the tire comprises a crown reinforcement radially interposed between the carcass reinforcement and the tread.

Advantageously, the crown reinforcement comprises a working reinforcement comprising at least two working plies, each working ply comprising several reinforcing elements referred to as working reinforcing elements arranged side by side parallel to one another, the working reinforcing elements making an angle ranging from 10° to 45° with the circumferential direction of the tire.

Advantageously, the working reinforcing elements are crossed from one working ply with respect to the other.

Advantageously, the crown reinforcement comprises a hoop reinforcement comprising at least one hooping ply comprising reinforcing elements referred to as hoop reinforcing elements arranged side by side parallel to one another, the hoop reinforcing elements making an angle at most equal to 10° with the circumferential direction of the tire.

The hoop reinforcement has the prime function of containing the working plies which, at high speed, are subjected to centrifugal force.

Advantageously, the crown reinforcement comprises a protective reinforcement comprising at least one protective ply comprising reinforcing elements referred to as protective reinforcing elements arranged side by side parallel to one another, the protective reinforcing elements making an angle at least equal to 10°, preferably ranging from 10° to 35° and more preferably from 15° to 30° with the circumferential direction of the tire.

Advantageously, the crown reinforcement comprises a triangulation reinforcement comprising at least one triangulation ply comprising reinforcing elements referred to as triangulation reinforcing elements arranged side by side parallel to one another, the triangulation reinforcing elements making an angle ranging from 30° to 65° with the circumferential direction of the tire.

In one preferred embodiment, the tire is for industrial vehicles, preferably for road haulage vehicles.

The invention will be better understood from reading the description which will follow, given solely by way of nonlimiting example and made with reference to the drawings in which:

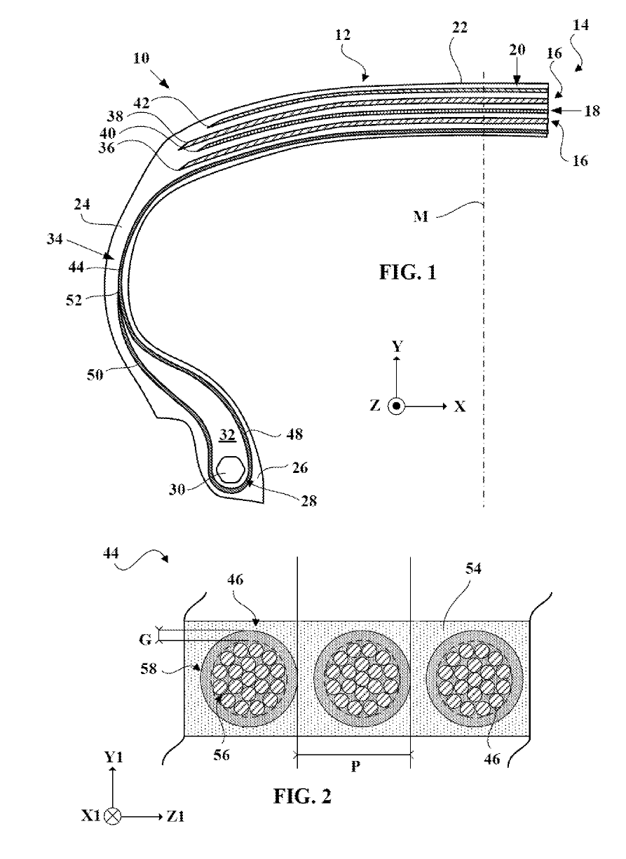

FIG. 1 is a view in section of a tire according to a first embodiment of the invention;

FIG. 2 is a view in section of a carcass ply of the tire of FIG. 1;

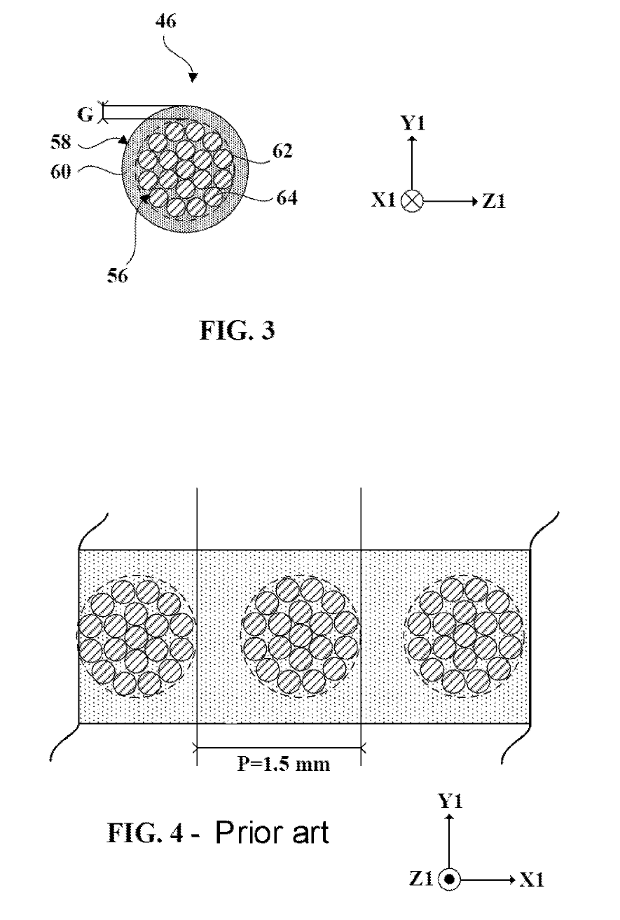

FIG. 3 is a view in section of a carcass reinforcing element of the carcass ply of FIG. 2; and

FIG. 4 is a view similar to that of FIG. 2 of a carcass ply of a tire of the prior art.

In the description which follows, when using the term “radial” it is appropriate to make a distinction between the various different uses made of this word by those skilled in the art. Firstly, the expression refers to a radius of the tire. It is in this sense that a point, a ply or a reinforcement P1 is said to be “radially inside” a point, a ply or a reinforcement P2 (or “radially on the inside of” the point P2) if it is closer to the axis of rotation of the tire than is the point, the ply or the reinforcement P2. Conversely, a point, a ply or a reinforcement P3 is said to be “radially outside” a point, a ply or a reinforcement P4 (or “radially on the outside of” the point, a ply or a reinforcement P4) if it is further away from the axis of rotation of the tire than is the point, the ply or the reinforcement P4. Progress will be said to be “radially inwards (or outwards)” when it is in the direction towards smaller (or larger) radii. It is this sense of the term that applies also when matters of radial distances are being discussed.

By contrast, a reinforcing element or a reinforcement is said to be “radial” when the reinforcing element or the reinforcing elements of the reinforcement make an angle greater than or equal to 80° and less than or equal to 90° with the circumferential direction.

An “axial” direction is a direction parallel to the axis of rotation of the tire. A point, a ply or a reinforcement P5 is said to be “axially inside” a point, a ply or a reinforcement P6 (or “axially on the inside of” the point, the ply or the reinforcement P6) if it is closer to the median plane M of the tire than is the point, the ply or the reinforcement P6. Conversely, a point, a ply or a reinforcement P7 is said to be “axially outside” a point P8 (or “axially on the outside of” the point, the ply or the reinforcement P8) if it is further away from the median plane M of the tire than is the point, the ply or the reinforcement P8. The “median plane” M of the tire is the plane which is normal to the axis of rotation of the tire and lies equal distances from the annular reinforcing structures of each bead.

A “circumferential” direction is a direction which is perpendicular both to a radius of the tire and to the axial direction.

Furthermore, any range of values denoted by the expression “from a to b” means the range of values extending from the end-point “a” to the end-point “b”, namely including the strict end-points “a” and “b”.

Example of a Tire According to the Invention

A frame of reference X, Y, Z corresponding to the usual axial (X), radial (Y) and circumferential (Z) directions of a tire respectively has been indicated in the figures.

FIG. 1 depicts a tire according to a first embodiment of the invention and denoted by the overall reference 10. The tire 10 is substantially axisymmetric about an axis substantially parallel to the axial direction X. The tire 10 here is intended for an industrial vehicle, for example a road haulage vehicle and in this instance a lorry. The tire 10 has the dimensions 315/70R22.5.

The tire 10 comprises a crown 12 comprising a crown reinforcement 14 comprising a working reinforcement 16, a hoop reinforcement 18 and a protective reinforcement 20.

The crown reinforcement 14 is surmounted by a tread 22. Two sidewalls 24 extend the crown 12 radially towards the inside of the tire 10. The tire 10 furthermore comprises two beads 26 radially on the inside of the sidewalls 24 and each comprising an annular reinforcing structure 28, in this instance a bead wire 30, surmounted by a mass of filling rubber 32.

The tire 10 also comprises a radial carcass reinforcement 34. The crown reinforcement 14 is radially interposed between the carcass reinforcement 34 and the tread 22. Each sidewall 24 connects each bead 26 to the crown 12.

The working reinforcement 16 comprises first and second working plies 36, 38 of working reinforcing elements (which have not been depicted). The first working ply 36 is arranged radially on the inside of the second working ply 38. The working reinforcing elements are arranged side by side parallel to one another and make an angle ranging from 10° to 45° with the circumferential direction Z of the tire 10, here an angle equal to 18°. The working reinforcing elements are crossed from one working ply with respect to the other. The working reinforcing elements are metallic assemblies of 11.35 type.

The hoop reinforcement 18 comprises a hooping ply 40. The hoop reinforcement 18 is radially interposed between the first and second working ply 36, 38. The hooping ply 40 comprises hoop reinforcing elements (which have not been depicted) arranged side by side parallel to one another and making an angle at most equal to 10° with the circumferential direction Z of the tire 10, here an angle equal to 0°. The hoop reinforcing elements are metallic assemblies of 21.23 type.

The protective reinforcement 20 comprises a protective ply 42 comprising protective reinforcing elements arranged side by side parallel to one another (which have not been depicted). The protective reinforcement 20, in this case the protective ply 42, is radially on the outside of the other reinforcements and radially on the inside of the tread 22. The protective reinforcing elements make an angle at least equal to 10°, preferably ranging from 10° to 35° and more preferably from 15° to 30° with the circumferential direction Z of the tire 10, here equal to 18°. The protective reinforcing elements are metallic assemblies of 6.35 type.

The carcass reinforcement 34 preferably comprises a single carcass ply 44 of radial carcass reinforcing elements 46 visible in greater detail in FIGS. 2 and 3.

The carcass reinforcement 34 is anchored in each of the beads 26 by a turnup around the bead wire 30 so as to form, in each bead 26, a main strand 48 extending from the beads 26 through the sidewalls 24 as far as the crown 12, and a turnup 50, the radially outer end 52 of the turnup 50 being radially on the outside of the annular reinforcing structure 28. The carcass reinforcement 32 thus extends from the beads 24 through the sidewalls 22 into the crown 12. In this embodiment, the carcass reinforcement 34 also extends axially through the crown 12.

Each working ply 36, 38, hooping ply 40, protective ply 42 and carcass ply 44 comprises an elastomer matrix 54 in which the reinforcing elements of the corresponding ply are embedded. The rubber compositions for the elastomer matrices 54 are compositions which are conventional for skimming reinforcing elements conventionally containing a diene elastomer, for example natural rubber, a reinforcing filler, for example carbon black and/or silica, a cross-linking system, for example a vulcanization system, preferably containing sulphur, stearic acid and zinc oxide, and possibly a vulcanization retarder and/or an accelerator and/or various additives.

FIGS. 2 and 3 respectively depict cross sections of the carcass ply 44 and of a carcass reinforcing element 46 on a plane of section perpendicular to the axial direction X. The carcass reinforcing elements 46 are arranged side by side parallel to one another in a main direction Z1. The carcass reinforcing elements 46 extend in an overall direction X1 and make an angle greater than or equal to 80° and less than or equal to 90° with the circumferential direction Z of the tire 10. Here, the overall direction X1 in which the carcass reinforcing elements 46 extend is substantially parallel to the axial direction X and the angle that these carcass reinforcing elements make with the circumferential direction Z of the tire 10 is therefore here equal to 90°.

Each carcass reinforcing element 46 comprises at least one filamentary element 56 and at least one sheath 58 coating the filamentary element 56 and comprising at least one layer 60 of a thermoplastic polymer composition.

Each carcass reinforcing element 46 comprises a single filamentary element 56. Each filamentary element 56 comprises an assembly 62 of individual metal threads 64.

Here, the assembly comprises an internal layer of one or M>1 individual metal threads 64, an intermediate layer of N>1 individual metal threads 64 wound in a helix around the internal layer and an external layer of P>1 individual metal threads 64 wound in a helix around the intermediate layer.

In this instance, each individual metal thread 64 is here made of steel coated with a protective coating for example containing brass or zinc. Each individual metal thread 64 has a diameter ranging from 0.10 mm to 0.35 mm, preferably from 0.12 mm to 0.26 mm and more preferably from 0.14 mm to 0.23 mm and here equal to 0.18 mm. Here, the assembly 62 is of the 1+6+12 type and has no wrapping wire. According to the nomenclature in usage, the assembly 62 is referred to as 19.18NF.

The sheath 58 has a mean thickness G on the back of each filamentary element 56 in the direction Y1 perpendicular to the main direction Z1 ranging from 1 μm to 2 mm, preferably from 10 μm and 1 mm and more preferably from 35 μm to 200 μm. Here, G=150 μm.

The sheath 58 comprises a single layer 60 of the thermoplastic polymer composition comprises a thermoplastic polymer, a functionalized diene elastomer, a poly (p-phenylene ether) or a mixture of these materials. Here, the thermoplastic polymer composition comprises a thermoplastic polymer, for example polyamide 66. Optionally, the thermoplastic polymer composition may comprise a functionalized diene elastomer, for example a thermoplastic stirene comprising an epoxide, carbonyl, anhydride or ester functional group and/or a poly-p-phenylene ether.

The sheath 58 is coated with a layer of tackifying adhesive (not depicted) promoting adhesion between the sheath 58 and the elastomer matrix 54.

The mean laying pitch P of the carcass reinforcing elements 46 in the main direction Z1 is strictly greater than 1.5 mm, advantageously greater than or equal to 1.7 mm, preferably greater than or equal to 1.8 mm and more particularly greater than or equal to 1.9 mm. Here, P=2.0 mm.

Comparative Tests

The tire 10 according to the invention described hereinabove was compared against a control tire T of the prior art. The control tire T is identical to the tire 10 according to the invention except for its carcass ply depicted in FIG. 4. The carcass ply of the control tire T comprises carcass reinforcing elements comprising assemblies of individual metal threads of type 19.18 directly embedded in an elastomer matrix and therefore having no sheath. Furthermore, the mean laying pitch of the carcass reinforcing elements of the control tire T is equal to 1.5 mm.

The tires T and 10 were subjected to a low-pressure running test. During this test, the tires T and 10 were run until the tire burst. The greater the distance covered, the better the endurance of the tire to the low-pressure running test.

The mass of metal in the carcass ply of each tire T and 10 was also weighed, which means to say the mass of metal carcass reinforcing elements. The masses of metal were then referenced to base 100 with respect to the carcass ply of the control tire T. The greater the extent to which the value obtained is above 100, the lighter in weight the carcass ply is.

The results are collated in table 1 below.

TABLE 1

| Tire performances | T | 10 |
|---|---|---|
| Mass of metal in the carcass ply (base 100) | 100 | 125 |
| Distance covered during the low-pressure | 100 | 99 |
| running test (km) | | |

Thus, it is found that for a lower mass of tire T the invention makes it possible to obtain a low-pressure running endurance that is almost identical to that of the tire T.

The invention is not restricted to the embodiments described hereinabove.

Specifically, it is also possible to conceive of a tire according to the invention in which the crown reinforcement also comprises a triangulation reinforcement. Such a triangulation reinforcement comprises at least one triangulation ply comprising reinforcing elements referred to as triangulation reinforcing elements arranged side by side parallel to one another. The triangulation reinforcing elements make an angle ranging from 30° to 65° with the circumferential direction of the tire.

It is also possible to conceive of a tire comprising several carcass plies at least one of which is as described hereinabove.

1. A tire comprising a crown surmounted by a tread, two sidewalls, two beads, each sidewall connecting each bead to the crown, a carcass reinforcement anchored in each of the beads and extending in the sidewalls as far as the crown, the carcass reinforcement comprising at least one carcass ply comprising carcass reinforcing elements arranged side by side parallel to one another in a main direction substantially perpendicular to the overall direction in which the carcass reinforcing elements extend at a mean laying pitch strictly greater than 1.5 mm, the carcass ply comprising an elastomer matrix in which the carcass reinforcing elements are embedded, wherein each carcass reinforcing element comprises:
at least one filamentary element, and
at least one sheath coating the filamentary element and comprising at least one layer of a thermoplastic polymer composition.

2. The tire according to claim 1, wherein the mean laying pitch of the carcass reinforcing elements in the main direction is greater than or equal to 1.7 mm.

3. The tire according to claim 1, wherein the mean thickness of the sheath on the back of each filamentary element ranges from 1 μm to 2 mm.

4. The tire according to claim 1, wherein each filamentary element comprises an assembly of individual metal threads.

5. The tire according to claim 1, wherein each individual metal thread has a diameter ranging from 0.10 mm to 0.35 mm.

6. The tire according to claim 1, wherein the thermoplastic polymer composition comprises a thermoplastic polymer, a functionalized diene elastomer, a poly(p-phenylene ether) or a mixture of these materials.

7. The tire according to claim 1, wherein the carcass reinforcing elements make an angle ranging from 80° to 90° with the circumferential direction of the tire.

8. The tire according to claim 1, comprising a crown reinforcement radially interposed between the carcass reinforcement and the tread.

9. The tire according to claim 8, wherein the crown reinforcement comprises a working reinforcement comprising at least two working plies, each said working ply comprising several reinforcing elements referred to as working reinforcing elements arranged side by side parallel to one another, the working reinforcing elements making an angle ranging from 10° to 45° with the circumferential direction of the tire.

10. The tire according to claim 9, wherein the working reinforcing elements are crossed from one working ply with respect to the other.

11. The tire according to claim 8, wherein the crown reinforcement comprises a hoop reinforcement comprising at least one hooping ply comprising reinforcing elements referred to as hoop reinforcing elements arranged side by side parallel to one another, the hoop reinforcing elements making an angle at most equal to 10° with the circumferential direction of the tire.

12. The tire according to claim 8, wherein the crown reinforcement comprises a protective reinforcement comprising at least one protective ply comprising reinforcing elements referred to as protective reinforcing elements arranged side by side parallel to one another, the protective reinforcing elements making an angle at least equal to 10° with the circumferential direction of the tire.

13. The tire according to claim 8, wherein the crown reinforcement comprises a triangulation reinforcement comprising at least one triangulation ply comprising reinforcing elements referred to as triangulation reinforcing elements arranged side by side parallel to one another, the triangulation reinforcing elements making an angle ranging from 30° to 65° with the circumferential direction of the tire.

14. The tire according to claim 1, for industrial vehicles, preferably for road haulage vehicles.

15. The tire according to claim 1, wherein the mean laying pitch of the carcass reinforcing elements in the main direction is greater than or equal to 1.8 mm.

16. The tire according to claim 1, wherein the mean thickness of the sheath on the back of each filamentary element ranges from 10 μm to 1 mm.

17. The tire according to claim 1, wherein each individual metal thread has a diameter ranging from 0.12 mm to 0.26 mm.

18. The tire according to claim 8, wherein the crown reinforcement comprises a protective reinforcement comprising at least one protective ply comprising reinforcing elements referred to as protective reinforcing elements arranged side by side parallel to one another, the protective reinforcing elements making an angle ranging from 10° to 35° with the circumferential direction of the tire.
